(19) United States
(12) Patent Application Publication
(10) Pub. No.: US 2026/0099115 A1
(43) Pub. Date: Apr. 9, 2026

(54) FIXING DEVICE

(71) Applicant: CANON KABUSHIKI KAISHA, Tokyo (JP)

(72) Inventors: RYO YASHIRO, Tokyo (JP); MADOKA WATANABE, Chiba (JP); AKIHIRO MAEDA, Tokyo (JP); SHIGEAKI TAKADA, Chiba (JP); YUSUKE YAMAGUCHI, Chiba (JP)

(21) Appl. No.: 19/314,045

(22) Filed: Aug. 29, 2025

(30) Foreign Application Priority Data
Oct. 8, 2024 (JP) 2024-176237

(51) Int. Cl. G03G 15/20

(52) U.S. Cl. CPC G03G 15/2025; G03G 15/2064; G03G 2215/2035

(57) ABSTRACT

A fixing device includes an endless fixing belt, a steering roller to move the fixing belt in a widthwise direction and a lubricant applying member extended inside the fixing belt and in the widthwise direction, and to apply a lubricant to an inner peripheral surface of the fixing belt by contacting the inner peripheral surface. With respect to the widthwise direction, the lubricant applying member includes a first region, and a second region provided on both ends of the first region and in which an amount of the lubricant contained per unit length is smaller than that in the first region. In a state in which the fixing belt is deviated in a first direction side most by the steering roller, a belt end portion on a side opposite to the first direction side is positioned in the second region.

### BACKGROUND

### Field of the Technology

The present invention relates to a fixing device suitable for use in an image forming apparatus such as a printer, a copy machine, a facsimile machine or a multifunction machine.

### Description of the Related Art

An image forming apparatus is provided with a fixing device which applies heat and pressure to a recording material, on which a toner image is formed, to fix the toner image to the recording material. In Japanese Patent Application Laid-Open No. 2023-104872, as a fixing device, a fixing device of a belt heating type which includes an endless fixing belt, a heating roller provided inside the fixing belt to heat the fixing belt, a pad contacting an inner peripheral surface of the fixing belt, and a pressing roller which pressurizes the fixing belt between the pad and itself to form a fixing nip portion which applies heat and pressure to a recording material is proposed. In the fixing device of the belt heating type, in order to suppress sliding resistance between the non-rotating pad and the rotating fixing belt, a lubricant is applied to the inner peripheral surface of the fixing belt by an applying roller impregnated with silicone oil, which is the lubricant.

In addition, in the device described in Japanese Patent Application Laid-Open No. 2023-104872, in order to remove the lubricant, which is pushed out from a central region toward an end portion region of the fixing belt and goes around from the inner peripheral surface to an outer peripheral surface via an edge portion of the fixing belt, a scraping member which removes the lubricant by contacting the edge portion of the fixing belt is provided. This is because if the lubricant is adhered to the outer peripheral surface of the rotating fixing belt, the lubricant is adhered to the recording material which passes through the fixing nip portion, and image quality of the toner image which has been fixed to the recording material is degraded.

### SUMMARY

According to an aspect of the present invention, there is provided a fixing device for fixing a toner image formed on a recording material onto the recording material, the fixing device comprising: an endless fixing belt; a stretching roller configured to stretch the fixing belt; a nip portion forming member provided inside the fixing belt and configured to form a nip portion which fixes the toner image on the recording material; a pressing rotatable member disposed across the fixing belt opposite to the nip portion forming member and configured to press the fixing belt; a steering roller configured to move the fixing belt in a widthwise direction crossing a conveyance direction of the recording material; and a lubricant applying member extended inside the fixing belt and in the widthwise direction, and configured to apply a lubricant to an inner peripheral surface of the fixing belt by contacting the inner peripheral surface, wherein with respect to the widthwise direction, the lubricant applying member includes a first region, and second regions provided on both ends of the first region and in which an amount of the lubricant contained per unit length is smaller than an amount of the lubricant contained per unit length in the first region, and wherein in a state in which the fixing belt is deviated in a first direction side most by the steering roller, a belt end portion on a side opposite to the first direction side is positioned in the second region.

Further features of the present invention will become apparent from the following description of exemplary embodiments with reference to the attached drawings.

### BRIEF DESCRIPTION OF THE DRAWINGS

FIG. 1 is an outline view illustrating an image forming apparatus in which a fixing device of the present Embodiment is suitably used.

FIG. 2 is an outline view illustrating the fixing device.

FIG. 3 is a schematic view illustrating a lubricant applying portion.

FIG. 4 is a view for explaining the lubricant applying portion.

FIG. 5 is a schematic view illustrating another Embodiment of an applying roller.

FIG. 6 is a schematic view illustrating still another Embodiment of the applying roller.

### DESCRIPTION OF THE EMBODIMENTS

### <Image Forming Apparatus>

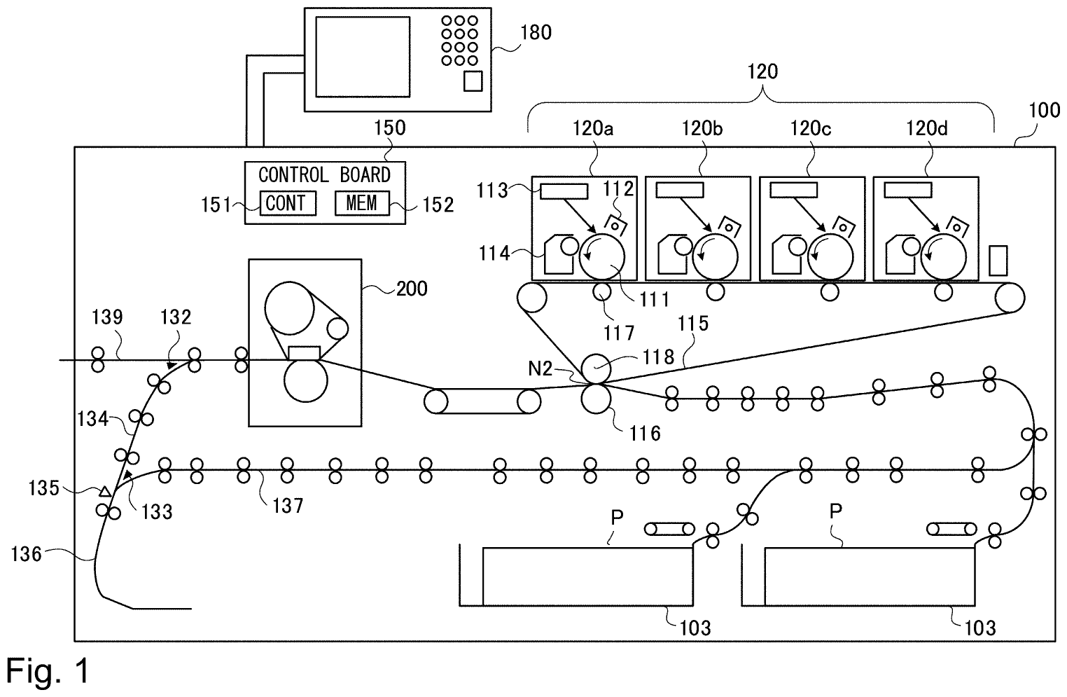

The present Embodiment will be described. First, a configuration of an image forming apparatus, in which a fixing device of the present Embodiment is suitably used, will be described using FIG. 1. In an image forming apparatus 100, along a moving direction of an intermediary transfer belt 115, four types of image forming portions of a yellow image forming portion 120a, a magenta image forming portion 120b, a cyan image forming portion 120c and a black image forming portion 120d are disposed. First, a process in which a toner image is formed on the intermediary transfer belt 115 will be described using the yellow image forming portion 120a as an example.

In FIG. 1, a surface of a photosensitive drum 111, which is rotationally driven, is uniformly charged by a charger 112 (charging). Thereafter, an exposure device 113 irradiates the surface of the photosensitive drum 111 with a laser according to input image data, and an electrostatic latent image is formed on the surface of the photosensitive drum 111 (exposure). Thereafter, a yellow toner image is formed on the photosensitive drum 111 by a developing device 114 (development). A primary transfer roller 117 applies voltage having reverse polarity to potential polarity of the yellow toner image to the intermediary transfer belt 115. As a result, the yellow toner image on the photosensitive drum 111 is transferred to the intermediary transfer belt 115 (primary transfer). Incidentally, yellow toner remaining on the surface of the photosensitive drum 111 without being transferred is removed from the surface of the photosensitive drum 111 by a drum cleaner (not shown). This series of processes is performed in the same manner in the magenta image forming portion 120b, the cyan image forming portion 120c and the black image forming portion 120d. As a result, a full-color toner image is formed on the intermediary transfer belt 115.

The toner image on the intermediary transfer belt 115 is conveyed to a secondary transfer portion N2, which is formed by a secondary transfer outer roller 116 and a secondary transfer inner roller 118. A recording material P is taken out one by one from a recording material cassette 103, and fed to the secondary transfer portion N2 in synchronization with a timing when the toner image is conveyed thereto. Then, the toner image on the intermediary transfer belt 115 is transferred to the recording material P (secondary transfer). The recording material P, to which the toner image has been transferred, is conveyed to a fixing device 200, and the toner image is fixed to the recording material P by being subjected to heat and pressure in the fixing device 200 (fixing). The recording material P, to which the toner image has been fixed, is discharged to an unshown discharge tray.

The image forming apparatus 100 can also perform a monochrome image formation. In a case of the monochrome image formation, only the black image forming portion 120d of the plurality of the image forming portions 120 is driven.

In a case in which the image formations are performed on both sides of the recording material P, when the transfer and the fixing of the toner image to a first surface (first side) is completed, the recording material P is guided to a conveyance path 134 by a flapper 132 provided inside the image forming apparatus after the fixing. Then, the recording material P is conveyed to a reversing portion 136. When a reversing sensor 135 detects a trailing end of the recording material P, a flapper 133 switches a conveyance direction of the recording material P to a reversing path 137. The image forming apparatus 100 conveys the reversed recording material P through the reversing path 137 to the image forming portion 120 again, and further to the fixing device 200. The recording material P, of which the printings for the both sides are completed, is guided to a discharging path 139 by the flapper 132, and discharged to an outside of the apparatus.

This process, beginning from the charging until the recording material P is discharged to the discharge tray, is referred to as an image forming process (print job). In addition, a period in which the image formation is being performed is referred to as “during image forming process (during print job)”.

An operating portion 180 is provided with a display screen and a selection key. The operating portion 180 performs display of a status of the image forming apparatus 100 on the display screen and reception of an instruction for operation from an operator through the selection key.

A control board 150 includes a control portion 151 and a memory 152, and controls each unit portion in the image forming apparatus 100 described above. The control portion 151 outputs, based on a detection signal input from various types of sensors and/or information stored in the memory 152, an output signal to each electric component to operate the electric component at a desired timing and with a required control amount. Therefore, it is this control portion 151 that actually performs the control of the electric components. The memory 152 stores information (data) necessary for the control of each unit portion, and the control portion 151 performs reading out and writing in of the information data stored in the memory 152.

### <Fixing Device>

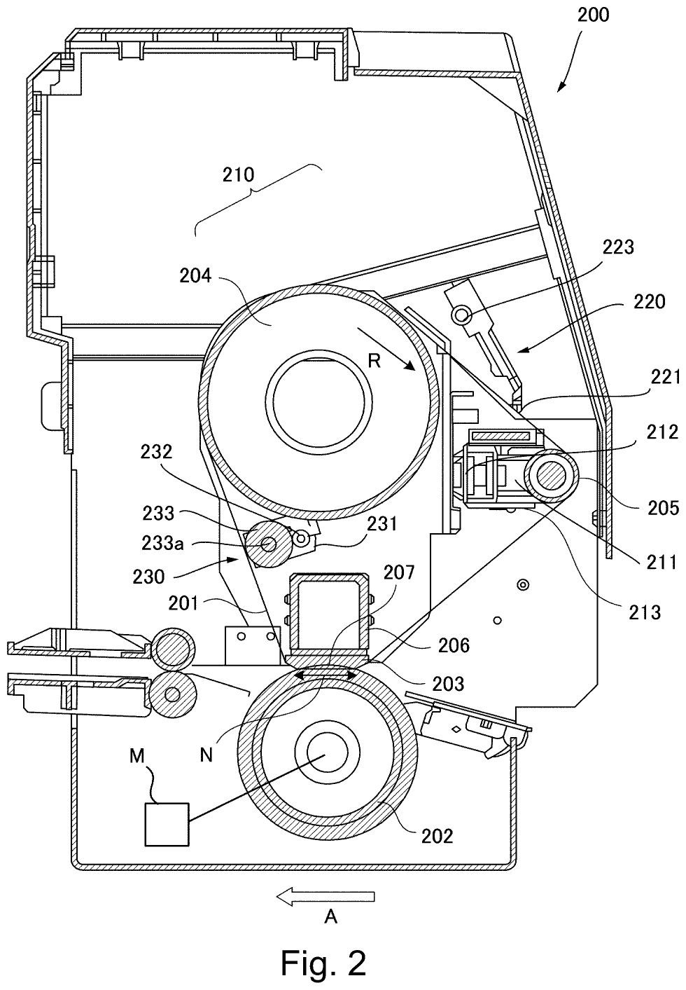

Next, a configuration of the fixing device 200 in the present Embodiment will be described using FIG. 2. The fixing device 200 in the present Embodiment is a fixing device of a belt heating type. In FIG. 2, the recording material P is conveyed in a conveyance direction from right to left (a direction of an arrow A). The fixing device 200 includes a heating unit 210, which includes a heat source, and a pressing roller 202 as a pressing rotatable member, which forms a fixing nip portion N together with the heating unit 210. The heating unit 210 includes an endless and rotatable fixing belt 201 as a rotatable heating member, a pad 203, a heating roller 204, a steering roller 205 and a lubricant applying portion 230.

### <Fixing Belt>

The fixing belt 201, of which a length in a longitudinal direction (widthwise direction crossing the conveyance direction of the recording material P) is “360 mm”, has thermal conductivity, heat resistance, etc., and has a cylindrical shape of a thin wall. In the present Embodiment, the fixing belt 301 has a three-layer structure in which a base layer is formed, an elastic layer is formed on an outer periphery of the base layer, and a releasing layer is formed on an outer periphery of the elasticity layer. And, the base layer has a thickness of “60 μm”, and polyimide resin (PI) is used for material thereof, the elastic layer has a thickness of “300 μm”, and silicone rubber is used for material thereof, and the releasing layer has a thickness of “30 μm”, and PFA (tetrafluoroethylene perfluoroalkoxyethylene copolymerization resin) as fluorine resin is used for material thereof. And, the fixing belt 201 is stretched by the pad 203, the heating roller 204 and the steering roller 205.

### <Pad>

The pad 203 is disposed on an inner peripheral side of the fixing belt 201, and is a nip portion forming member which forms the fixing nip portion N having a predetermined length in the conveyance direction of the recording material P (the direction of the arrow A) by making a press contact with the pressing roller 202 via the fixing belt 201. A cross-section thereof is substantially a rectangular, and the pad 203 is a member elongated along the longitudinal direction of the fixing belt 201. It is necessary for material of the pad 203 to have heat-resistance, and LCP (liquid crystal polymer) resin is used.

Between the pad 203 and the fixing belt 201, a sliding sheet 207, of which a surface is coated with PTFE (polytetrafluoroethylene), and silicone oil are interposed so that the fixing belt 201 slides smoothly against the pad 203. Incidentally, the silicone oil is used as the lubricant in the present Embodiment, however, it is not limited thereto but grease, etc. may be used.

### <Stay>

Inside the fixing belt 201, a stay 206 is disposed. The stay 206 is disposed inside the pad 203. The stay 206 is a reinforcing member which backs up the pad 203, is long in the longitudinal direction of the fixing belt 201, and has rigidity. For material thereof, a pultruded member of SUS304 (stainless steel) having a wall thickness of “3 mm” is used, and by a cross-section thereof being formed in a hollow of a rectangular shape, strength thereof is secured. The stay 206 secures the pressing force in the fixing nip portion N, upon the pad 203 being pressed by the pressing roller 202, by preventing the pad 203 from being flexed. Incidentally, the material of the stay 206 is not limited to the stainless steel as long as the strength thereof can be guaranteed.

### <Heating Roller>

The heating roller 204 as a stretching roller (first roller) is formed of a stainless steel pipe having a thickness of “1 mm”, and by an unshown halogen heater being disposed inside, the heating roller 204 can generate heat to a predetermined temperature. The fixing belt 201 is heated by the heating roller 204, and based on a temperature detection by a thermistor (not shown), is controlled to be at a predetermined target temperature corresponding to a type (basis weight) of the recording material P. In addition, it may be a configuration in which the heating roller 204 is rotationally driven. By the heating roller 204 being rotationally driven and making a rotation speed thereof faster than that of the pressing roller, in a rotational direction of the belt, it becomes possible to increase tension of the fixing belt 201 from the fixing nip portion N to the heating roller 204. By doing so, curvature on a downstream side of the fixing nip portion N in the rotational direction of the belt is increased, and it becomes possible to improve separating performance of the record material P from the fixing belt 201.

### <Steering Roller>

The steering roller 205 as a second roller stretches the fixing belt 201, and is supported by a steer frame 213. By the steer frame 213 being provided inclinably with respect to a frame of the heating unit 210 using a rotation shaft 212 as a fulcrum, the steering roller 205 changes alignment thereof with respect to other stretching members. As a result, by generating a tension difference between a front and a back of the fixing belt 201, in the longitudinal direction of the fixing belt 201, a position in the longitudinal direction of the fixing belt 201 is controlled. By reciprocating the fixing belt 201 in the longitudinal direction in this manner, it is configured so that the rotating fixing belt 201 is kept from being deviated too much to an end portion in the longitudinal direction with respect to the heating roller 204 (so-called belt deviation control). Incidentally, the steering roller 205 is urged by a spring 211 supported by the steer frame 213, and also serves as a tension roller which applies predetermined tension to the fixing belt 201. An axial direction of the rotation shaft 212 is the same as the conveyance direction of the recording material P in the fixing nip portion N. As a result, by the steering roller 205 being rotated, at least an end portion on one side of the steering roller 205 is moved downward and upward in a vertical direction.

In addition, the steering roller 205 also serves to suppress unevenness in gloss caused by an edge portion of the recording material P. In the present Embodiment, force of approximately “2000 N” is applied to the fixing belt 201 in the fixing nip portion N. Upon fixing the unfixed toner to the recording material P, a portion of the fixing belt 201 which contacts the edge portion of the recording material P is subjected to greater stress than a portion which does not contact the edge portion. In the contact portion which the edge portion of the recording material P repeatedly contact, a recessed shape relative to the non-contact portion which the edge portion of the recording material P does not contact is formed. In this manner, by the edge portion of the recording material P, the recess formed on a surface of the fixing belt 201 is referred to as a paper edge dent.

Upon fixing the unfixed toner to the recording material P, the fixing device 200 applies pressure and heat to the recording material P. At this moment, a surface condition of the fixing belt 201 is reflected to gloss of an image surface after the fixing. If irregularities exist on the surface of the fixing belt 201, that condition of the irregularities is reflected to the gloss of the image surface, and as a result, the unevenness in gloss (gloss unevenness) is generated on the image surface. Therefore, when the unfixed toner image is fixed to the recording material P in the state in which the paper edge dent is formed on the surface of the fixing belt 201, the gloss unevenness, which seems that a straight line is drawn on the surface on the image surface, is generated. Therefore, in the present Embodiment, in order to suppress the paper edge dent on the surface of the fixing belt 201, the fixing belt 201 is reciprocated in the longitudinal direction thereof. By this, by distributing in the longitudinal direction a number of times at which the fixing belt 201 contacts the edge portion of the recording material P, it becomes possible to suppress the paper edge dent.

Although illustration in the figures is omitted, in order to detect the position of the fixing belt 201 in the longitudinal direction, a belt position detecting portion is provided. In the belt position detecting portion, an arm which abuts the fixing belt 201 from an outer side to an inner side in the longitudinal direction is provided at an end portion of the fixing belt 201, and by detecting a position of the arm with a sensor such as a photo interrupter, it becomes possible to detect the position of the fixing belt 201 in the longitudinal direction. In order to accurately detect the position of the fixing belt 201 in the longitudinal direction, the direction in which the arm applies force to the fixing belt 201 is the direction heading from the outer side to the inner side of the fixing belt 201 in the longitudinal direction. In addition, in order to apply the force in this direction, a rotational axis of the arm is in a direction perpendicular to the longitudinal direction. Therefore, the arm which detects the position of the fixing belt 201 in the longitudinal direction is rotated in the longitudinal direction about the rotational axis.

By performing the belt deviation control according to the detection result of the photo interrupter, it becomes possible to suppress the fixing belt 201 from coming off the members stretching the fixing belt 201 (the pad 203, the heating roller 204 and the steering roller 205). In addition, it becomes possible to actively move the fixing belt 201 in the longitudinal direction for the countermeasure against the edge dent.

### <Pressing Roller>

The pressing roller 202 is a roller in which an elastic layer is formed on an outer periphery of a shaft thereof, and a release layer is formed on an outer periphery of the elastic layer. Stainless steel is used for the shaft, conductive silicone rubber having a thickness of “5 mm” is used for the elasticity layer, and PFA as fluorine resin having a thickness of “50 μm” is used for the releasing layer. The pressing roller 202 is supported via the shaft thereof by a fixing frame 380 of the fixing device 200, a gear is fixed to one end portion thereof, and is rotationally driven by being connected to a driving source M via the gear. The fixing belt 201 is rotated driven in a clockwise direction (a direction of an arrow R) by being nipped by the rotating pressing roller 202 and the pad 203.

In this manner, to the inner peripheral surface of the fixing belt 201, the pad 203, the heating roller 204 and the steering roller 205 are provided, and stretch the fixing belt 201. The fixing belt 201 is nipped by the pressing roller 202 and the pad 203, and is rotated driven by the pressing roller 202 being rotationally driven. The fixing belt 201 stores the heat from the heating roller 204. When the recording material P carrying the unfixed toner image is nipped and conveyed by the pressing roller 202 and the fixing belt 201 in the fixing nip portion N, the heat and the pressure required for the fixing are applied thereto. As a result, the toner image is fixed onto the recording material P.

### <Lubricant Applying Portion>

The lubricant applying portion 230 includes a lubricant accommodating member 231 in which the silicone oil (hereinafter, lubricant) is accommodated, a taking out roller 232 made of metal, and an applying roller 233 in contact with the taking out roller 232. The applying roller 233 is provided inside the fixing belt 201 with extending in the widthwise direction (longitudinal direction). The applying roller 233 is brought into contact with the inner peripheral surface of the fixing belt 201 by a pressing spring (not shown) at “3.0 N”, and is supported by the frame of the heating unit 210 so as to be capable of being rotated driven by the fixing belt 201. The applying roller 233 as a lubricant applying member is a roll shaped member of which, for example, a rotational shaft 233a is wound around by nonwoven fibers impregnatable with the lubricant with a thickness of “100 μm” and a length in the longitudinal direction is “365 mm”. As the nonwoven fibers, for example, nonwoven fibers having a thickness about “50 through 150 μm” in which aramid fibers and polyethylene terephthalate (PET) fibers, which have excellent heat resistance, are mixed with a weight ratio of “3:7” are used.

The taking out roller 232 as a lubricant supplying member is supported, so as a portion thereof to be immersed in the lubricant accommodated in the lubricant accommodating member 231, by the frame of the heating unit 210 so as to be capable of being rotated driven by the applying roller 233. The taking out roller 232, by being rotated, takes out the lubricant from the lubricant accommodating member 231. The applying roller 233, by being rotated, applies the lubricant taken out by the taking out roller 232 to the inner peripheral surface of the fixing belt 201. In other words, when the fixing belt 201 is rotated, the lubricant supplied from the taking out roller 232 is held by the applying roller 233 and applied to the fixing belt 201. On the other hand, when the fixing belt 201 is not rotated, a portion of the lubricant held by the applying roller 233 is returned to the lubricant accommodating member 231 through the taking out roller 232.

The lubricant interposed between the pad 203 and the fixing belt 201 is deteriorated with the operation of the fixing device 200 and may decrease due to leakage to an outside, etc. If the lubricant between the pad 203 and the fixing belt 201 decreases, sliding resistance between the pad 203 and the fixing belt 201 is increased, and a problem such as rotation defect of the fixing belt 201 may arise. Therefore, as described above, it is configured that the lubricant is supplied to the inner peripheral surface of the fixing belt 201 by the lubricant applying portion 230. By this, the lubricant interposed between the pad 203 and the fixing belt 201 is maintained and the sliding resistance does not get increased, so that it becomes possible to rotate the fixing belt 201 stably over a longer period of time.

### <Degradation of Image Quality Due to Lubricant>

As in the present Embodiment, the lubricant is used for the fixing device 200 using the fixing belt 201. The lubricant is applied to the inner peripheral surface of the fixing belt 201 by the applying roller 233 as described above. In the fixing nip portion N, since the pressing force is generated by the pad 203 and the pressing roller 202, onto the lubricant applied to the inner peripheral surface of the fixing belt 201, force pushing out the lubricant from the inner peripheral surface to the end portion side of the fixing belt 201 in the longitudinal direction acts. Then, the lubricant is exposed from the end portion of the fixing belt 201 in the longitudinal direction.

In addition, in the present Embodiment, with using the steering roller 205, the fixing belt 201 is reciprocated in the longitudinal direction. Here, if there is the lubricant exposed from the end portion of the fixing belt 201 in the longitudinal direction, the lubricant may go around to the outer peripheral surface of the fixing belt 201 and be adhered to the outer peripheral surface. And, since the fixing belt 201 is rotated in the direction of the arrow R in FIG. 2, the lubricant adhered to the outer peripheral surface of the fixing belt 201 reaches the fixing nip portion N. Then, the lubricant is adhered to the recording material P conveyed to the fixing nip portion N, and image defect such that image quality of the toner image is degraded in a region where the lubricant is adhered may occur. Therefore, it is necessary to suppress that the lubricant is adhered to the outer peripheral surface of the fixing belt 201.

### <Collecting Mechanism>

Therefore, in the present Embodiment, in light of the point described above, a collecting mechanism 220 is provided to suppress the lubricant from going around from the inner peripheral surface to the outer peripheral surface of the fixing belt 201. The collecting mechanisms 220 are disposed at both end portions of the fixing belt 201 in the longitudinal direction. It may be a configuration in which the collecting mechanism 220 is disposed at one end portion side, however, since it becomes possible to collect the lubricant leaking from both end portions of the fixing belt 201, it is preferable to dispose the collecting mechanisms 220 at both end portions. The collecting mechanism 220 includes a scraping member 221 which contacts the end portion of the fixing belt 201, a dropping member (not shown) for dropping the lubricant, and a supporting member 223 to make the scraping member 221 be capable of following the reciprocating move of the fixing belt 201.

The scraping member 221 and the dropping member are disposed, in the rotational direction of the fixing belt 201, between the heating roller 204 and the steering roller 205. The scraping member 221 and the dropping member are movable or rotatable with the supporting member 223 as a rotation shaft. An axial direction of the supporting member 223 is configured to be parallel to a rotational axis direction of the heating roller 204. The scraping member 221 applies force in a direction heading from the outer peripheral surface side of the fixing belt 201 to the inner peripheral surface side of the fixing belt 201 to the fixing belt 201. The scraping member 221 as a removing member contacts an edge portion of the outer peripheral surface side of the fixing belt 201, and removes the lubricant which has moved from the inner peripheral surface to the outer peripheral surface of the fixing belt 201. The lubricant removed from the outer peripheral surface by the scraping member 221 is collected by a receiving member (not shown) via the dropping member. As a result, a passage to suitably collect the lubricant applied to the inner peripheral surface of the fixing belt 201 is established, and it becomes possible to suppress the leakage of the lubricant for the fixing belt 201.

By the way, as described above, in the present Embodiment, with using the steering roller 205, the fixing belt 201 is reciprocated in the longitudinal direction. By the fixing belt 201 being reciprocated in the longitudinal direction, the lubricant is collected at both end portions of the fixing belt 201 with respect to the longitudinal direction, and may go around from the inner peripheral surface to the outer peripheral surface via the edge of the fixing belt 201 due to surface tension.

Conventionally, in a case in which an amount of the lubricant removed by the scraping member 221 is large and the image formations are performed to the recording material P over a long period of time, the removed lubricant may be adhered to other members such as the steering roller 205 and the pressing roller 202, and the image quality of the toner image may be degraded by the adhesion.

In addition, since the lubricant is continuously moved from the inner peripheral surface to the outer peripheral surface of the fixing belt 201 and removed, as a continued operation time of the fixing belt 201 gets long, the lubricant on the inner peripheral surface of the fixing belt 201 decreases, and as a result, the sliding resistance between the pad 203 and the fixing belt 201 may become larger.

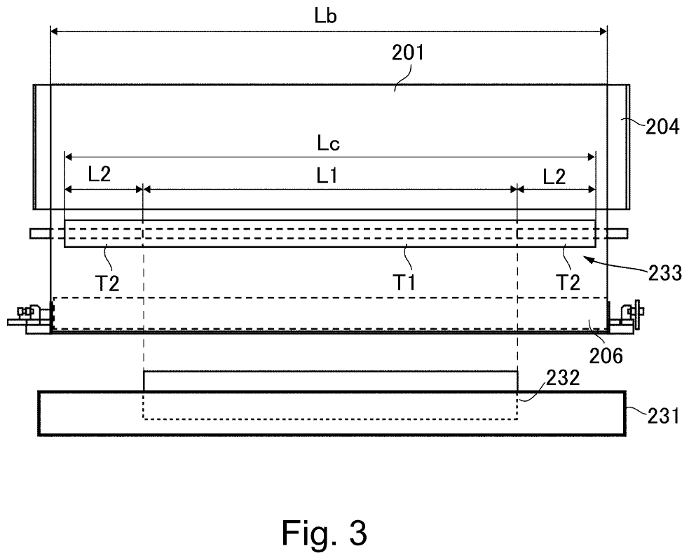

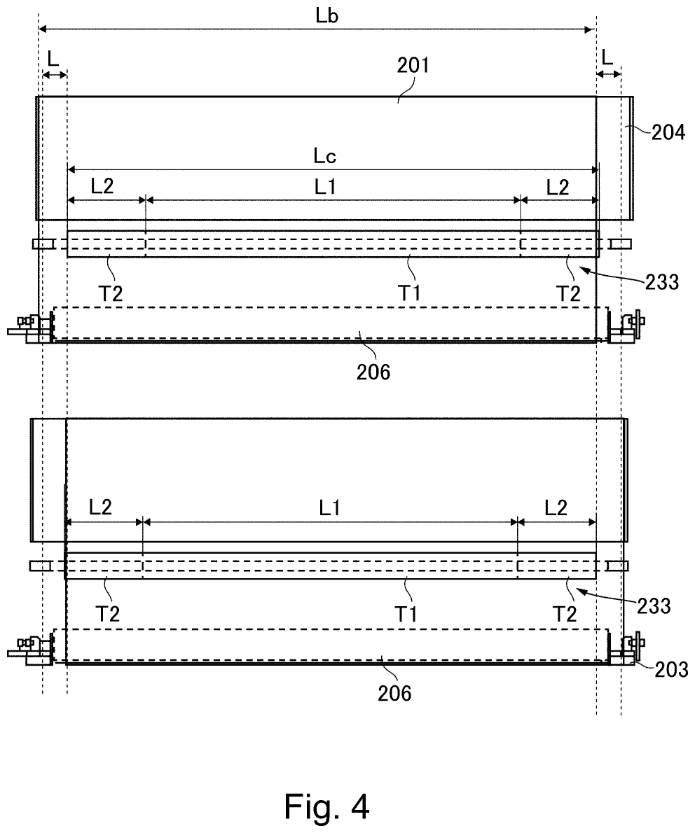

Therefore, the present Embodiment proposes the lubricant applying portion 230 in which it becomes less likely with the applying roller 233 for the lubricant applied to the inner peripheral surface of the fixing belt 201 to go around from the inner peripheral surface to the outer peripheral surface thereof. Hereinafter, the lubricant applying portion 230 in the present Embodiment will be described using FIG. 3 and FIG. 4. Incidentally, in FIG. 3, in order to make description easier to understand, the lubricant accommodating member 231 and the taking out roller 232 of the lubricant applying portion 230 are shown with positions thereof being shifted from their original positions. In addition, in FIG. 4, illustrations of the lubricant accommodating member 231 and the taking out roller 232 of the lubricant applying portion 230 are omitted.

As described above, the lubricant applying portion 230 includes the lubricant accommodating member 231, the taking out roller 232 and the applying roller 233. As shown in FIG. 3, as a region impregnatable with the lubricant, the applying roller 233 includes a central region T1 (first region) and end portion regions T2 (second regions) adjacent to both end portions of the central region T1, respectively, in the longitudinal direction. A length in the longitudinal direction of the central region T1 is “L1 (mm)”, and a length in the longitudinal direction of the end portion region T2 is “L2 (mm)”. To this applying roller 233, the lubricant taken out from the lubricant accommodating member 231 by the taking out roller 232 is supplied to the central region T1. In order to realize this, the taking out roller 232 is formed to have the same length in the longitudinal direction “L1 (mm)” as the central region T1 of the applying roller 233, and is disposed so as to contact an entire region of the central region T1 of the applying roller 233. In other words, in the applying roller 233, a contact region contacted by the taking out roller 232 is the central region T1, and regions not contacted by the taking out roller 232 are the end portion regions T2.

When the fixing belt 201 is rotated, the lubricant is supplied to the central region T1 of the applying roller 233 by the taking out roller 232. Thereafter, as the applying roller 233 is rotated following the rotation of the fixing belt 201, a portion of the lubricant is moved and spread from the central region T1 to the end portion regions T2 of the applying roller 233. In this manner, by the lubricant being impregnated to the central region T1 and the end portion regions T2 of the applying roller 233, it becomes possible to apply the lubricant to the inner peripheral surface of the fixing belt 201 over the longitudinal direction thereof.

In the present Embodiment, so that amounts of the lubricant impregnated in the applying roller 233 become different between the central region T1 and the end portion region T2, the applying roller 233, to which the lubricant is impregnated to each of the central region T1 and end portion region T2 with different amounts of the lubricant through a predetermined way in advance, is used. When the amount of the lubricant impregnated in the central region T1 is defined as “S1 (g)” and the amount of the lubricant impregnated in the end portion region T2 is defined as “S2 (g)”, the amount of the lubricant impregnated per unit length in the central region T1 of the applying roller 233 is “S1/L1 (g/mm)”. The amount of the lubricant impregnated per unit length in the end portion region T2 of the applying roller 233 is “S2/L2 (g/mm)”, which is less than “S1/L1 (g/mm)”. These “amount of the lubricant” per unit length are less than a maximum impregnated amount (impregnatable amount) per unit length with which the nonwoven fibers wound around the applying roller 233 is impregnatable.

In Table 1, results in which relationship between the amount of the lubricant “S1/L1 (g/mm)” impregnated in the central region T1 and the amount of the lubricant “S2/L2 (g/mm)” impregnated in the end portion region T2 and an exposed amount D (g) by which the lubricant is exposed to the end portion of the fixing belt 201 in the longitudinal direction is experimentally verified (Verification Experiment 1) are shown.

TABLE 1

| | Conventional | Embodi- | Embodi- | Embodi- |
|---|---|---|---|---|
| | Example | ment 1 | ment 2 | ment 3 |
| Overall: | 0.11 | 0.11 | 0.11 | 0.11 |
| Amount of lubricant | | | | |
| per unit length (g/mm) | | | | |
| Central region: | 0.11 | 0.12 | 0.13 | 0.14 |
| Amount of lubricant | | | | |
| per unit length (g/mm) | | | | |
| End portion region: | 0.11 | 0.1 | 0.03 | 0 |
| Amount of lubricant | | | | |
| per unit length (g/mm) | | | | |
| Exposed amount of | 5 | 4 | 3 | 1 |
| lubricant (g) | | | | |

In the present Verification Experiment 1, the length “L1” in the longitudinal direction of the central region T1 is set to “260 mm”, and the length “L2” in the longitudinal direction of the end portion region T2 is set to “40 mm (in total of left and right, 80 mm)”. In addition, a range of the reciprocated movement of the fixing belt 201 in the longitudinal direction by the steering roller 205 is set to “20 mm”. In the experiment, in a state in which the pressing between the fixing belt 201 and the pressing roller 202 is released, a surface temperature of the heating roller 204 is set to “200° C.”, and the fixing belt 201 is continuously rotated over a predetermined time period. Along with this, before the fixing belt 201 is rotated, the amount of the lubricant impregnated in the central region T1 and the amount of the lubricant impregnated in the end portion region T2 are varied (Embodiments 1 through 3), and weights of the lubricant exposed to the end portion of the fixing belt 201 in the longitudinal direction are measured.

As it can be seen from Table 1, by configuring the amount of the lubricant “S2/L2 (g/mm)” in the end portion region T2 to be less than the amount of the lubricant “S1/L1 (g/mm)” in the central region T1, it becomes possible to suppress the exposure of the lubricant to the end portion of the fixing belt 201 in the longitudinal direction compared to the Conventional Example. In addition, as the amount of the lubricant “S2/L2 (g/mm)” in the end portion region T2 is reduced and a difference with the amount of the lubricant in the central region T1 is large, it becomes possible to reduce the lubricant exposed to the end portion of the fixing belt 201 in the longitudinal direction. This is because an amount by which the lubricant, which has moved from the central region T1, is absorbed by the end portion region T2 is large. In the present Embodiment, in order to allow the end portion region T2 to absorb the lubricant which has moved from the central region T1 during the rotation of the fixing belt 201, the amount of the lubricant in the end portion region T2 is always less than the amount of the lubricant in the central region T1. Incidentally, as shown in the Embodiment 3, upon the lubricant being impregnated in advance through the predetermined way, it is preferable to make the amount of the lubricant in the end portion region T2 before the fixing belt 201 is rotated be “0 g”.

Next, the length of the end portion region T2 in the longitudinal direction will be described using FIG. 4. In FIG. 4, an upper shows a state in which the fixing belt 201 is deviated to left in FIG. 4, and a lower shows a state in which the fixing belt 201 is deviated to right in FIG. 4. As shown in FIG. 4, a length of the fixing belt 201 in the longitudinal direction is defined as “Lb (mm)”, and a length of the applying roller 233 in the longitudinal direction is defined as “Lc (mm)”. In this case, a difference between the lengths of the fixing belt 201 and the applying roller 233 in the longitudinal direction on one side is expressed as “½ (Lb-Lc)”. In addition, the fixing belt 201 is reciprocated in the longitudinal direction by the steering roller 205 being inclined. When a movement length (distance) thereof is defined as “L (mm)”, the length of the end portion region T2 of the applying roller 233 in the longitudinal direction “L2 (mm)” has a relationship of “½ (Lb-Lc)+L2>L”. By satisfying this relationship, even if the fixing belt 201 is reciprocated in the longitudinal direction, the end portion of the fixing belt 201 keeps contacting the end portion region T2 of the applying roller 233. As a result, it becomes possible to suppress that the lubricant is exposed to the end portion of the fixing belt 201 in the longitudinal direction. In addition, in the state in which the fixing belt 201 is deviated most to the right side by the steering roller 205, the end portion of the belt on the left side is positioned within the end portion region T2. Similarly, in the state in which the fixing belt 201 is deviated most to the left side by the steering roller 205, the end portion of the belt on the right side is positioned within the end portion region T2.

In Table 2, results in which relationship between the length “L2 (mm)” of the end portion region T2 in the longitudinal direction and the movement length of the reciprocation “L (mm)” of the fixing belt 201 and the exposed amount D (g) by which the lubricant is exposed to the end portion of the fixing belt 201 in the longitudinal direction is experimentally verified (Verification Experiment 2) are shown.

TABLE 2

| | Embodi- | Embodi- | Embodi- |
|---|---|---|---|
| | ment 4 | ment 5 | ment 6 |
| Overall: | 0.11 | 0.11 | 0.11 |
| Amount of lubricant per unit length | | | |
| (g/mm) | | | |
| End portion region: | 10 | 20 | 40 |
| Length in longitudinal direction (mm) | | | |
| Movement length of fixing belt (mm) | 20 | 20 | 20 |
| Exposed amount of lubricant (g) | 5 | 4 | 1 |

In the present Verification Experiment 2, the length “Lb” of the fixing belt 201 in the longitudinal direction is set to “340 mm”, the length “Lc” of the applying roller 233 in the longitudinal direction is set to “340 mm”, and the difference between the lengths of the fixing belt 201 and the applying roller 233 in the longitudinal direction is set to “0”. In this case, the relationship between the length “L2” of the end portion region T2 of the applying roller 233 in the longitudinal direction and the movement length “L” of the fixing belt 201 is verified. In the experiment, the conditions of the Embodiments 1 through 3 in the Verification Experiment 1 are used, that is, in the state in which the pressing between the fixing belt 201 and the pressing roller 202 is released, the surface temperature of the heating roller 204 is set to “200° C.”, the fixing belt 201 is continuously rotated over a predetermined time period, and the weights of the lubricant exposed to the end portion of the fixing belt 201 in the longitudinal direction are measured.

As it can be seen from Table 2, by making the length “L2” of the end portion region T2 of the applying roller 233 in the longitudinal direction larger than the movement length of the reciprocation “L” of the fixing belt 201, it becomes possible to suppress the exposure of the lubricant to the end portion of the fixing belt 201 in the longitudinal direction. A reason why the lubricant is exposed to the end portion of the fixing belt 201 in the longitudinal direction is, upon the fixing belt 201 being reciprocated, the lubricant adhered on the inner peripheral surface of the fixing belt 201 and the surface of the heating roller 204 is scraped up by the applying roller 233. Therefore, by making the length “L2” of the end portion region T2 in the longitudinal direction for absorbing the lubricant larger than the movement distance “L” of the reciprocation of the fixing belt 201, it becomes possible to suppress that the lubricant scraped up to the end portion side in the longitudinal direction by the applying roller 233 is exposed from the end portion in the longitudinal direction.

As described above, in the present Embodiment, with respect to the longitudinal direction, the amounts of the lubricant with which the applying roller 233 is impregnated differ between the central region T1 and the end portion region T2. The amount of the lubricant per unit length in the end portion region T2 is less than the amount of the lubricant per unit length in the central region T1. By configuring in this manner, during rotation of the fixing belt 201, even if a portion of the lubricant is moved as is pushed out from the central region T1 to the end portion region T2 of the fixing belt 201, the lubricant is absorbed by the end portion region T2. In order to allow the end portion region T2 to absorb the lubricant which has moved from the central region T1 during rotation of the fixing belt 201, the amount of the lubricant in the end portion region T2 is always less than the amount of the lubricant in the central region T1. In this manner, it becomes possible with the applying roller 233 to suppress that the lubricant is pushed out from the central region T1 to the end portion region T2 of the applying roller 233 and goes around from the inner peripheral surface to the outer peripheral surface via the edge of the fixing belt 201 and is adhered thereto.

Therefore, the lubricant is not adhered to the recording material P upon fixing the toner image to the recording material P, and the image quality of the fixed toner image is not degraded.

### OTHER EMBODIMENTS

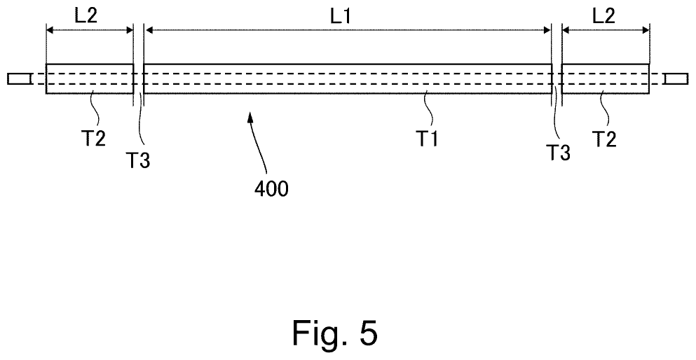

Next, another Embodiment of the applying roller will be described using FIG. 5. As shown in FIG. 5, in an applying roller 400, a gap T3 is formed between a central region T1 and an end portion region T2 with respect to the longitudinal direction. By forming the gap T3, since move of the lubricant from the central region T1 to the end portion region T2 is limited, even if the fixing belt 201 is rotated over a long period of time, it becomes possible to keep the end portion region T2 being impregnated with the lubricant.

It is preferable that the gap T3 is formed to have a length in the longitudinal direction of “1 mm or more and 3 mm or less”. It may be configured that the length in the longitudinal direction of the gap T3 is more than “3 mm”. However, in such a case, it may become necessary to shorten the length in the longitudinal direction of the end portion region T2, and the amount of the lubricant which can be collected or absorbed by the end portion region T2 (collecting amount) becomes less, so that it is preferable to form the gap T3 with “3 mm or less”. When the collecting amount of the end portion region T2 is small, it is undesirable since a time until when an impregnatable amount of the end portion region T2 is exceeded becomes shorter, and a time until when the lubricant is exposed to the end portion of the fixing belt 201 in the longitudinal direction becomes shorter.

In Table 3, for the case in which the gap T3 is provided, results in which relationship between the amount of the lubricant “S1/L1 (g/mm)” impregnated in the central region T1 and the amount of the lubricant “S2/L2 (g/mm)” impregnated in the end portion region T2 and the exposed amount D (g) by which the lubricant is exposed to the end portion of the fixing belt 201 in the longitudinal direction is experimentally verified (Verification Experiment 3) are shown.

TABLE 3

| | Conventional | Embodi- | Embodi- | Embodi- |
|---|---|---|---|---|
| | Example | ment 7 | ment 8 | ment 9 |
| Overall: | 0.11 | 0.11 | 0.11 | 0.11 |
| Amount of lubricant | | | | |
| per unit length (g/mm) | | | | |
| Central region: | 0.11 | 0.12 | 0.13 | 0.14 |
| Amount of lubricant | | | | |
| per unit length (g/mm) | | | | |
| End portion region: | 0.11 | 0.1 | 0.03 | 0 |
| Amount of lubricant | | | | |
| per unit length (g/mm) | | | | |
| Exposed amount of | 5 | 4 | 1.5 | 0 |
| lubricant (g) | | | | |

In the present Verification Experiment 3, as in the Verification Experiment 1, the length “L1” of the central region T1 in the longitudinal direction is set to “260 mm”, and the length “L2” of the end portion region T2 in the longitudinal direction is set to “40 mm (in total of left and right, 80 mm)”. In addition, a range of the reciprocated movement of the fixing belt 201 in the longitudinal direction by the steering roller 205 is set to “20 mm”. In the experiment, in the state in which the pressing between the fixing belt 201 and the pressing roller 202 is released, the surface temperature of the heating roller 204 is set to “200° C.”, and the fixing belt 201 is continuously rotated over a predetermined time period. Along with this, before the fixing belt 201 is rotated, the amount of the lubricant impregnated in the central region T1 and the amount of the lubricant impregnated in the end portion region T2 are varied (Embodiments 7 through 9), and weights of the lubricant exposed to the end portion of the fixing belt 201 in the longitudinal direction are measured. Incidentally, the Conventional Example and the Embodiment 7 are the cases in which the gap T3 is not provided, and the results are the same as those of the Conventional Example and the Embodiment 1 in Table 1 described above. The Embodiment 8 is a case in which the gap T3 is provided, but is a case in which the gap T3 is smaller than “1 mm”.

As it can be seen from the Embodiment 9 in Table 3, in a case in which the amount of the lubricant in the end portion region T2 before the fixing belt 201 is rotated is “0 (g/mm)”, by providing the gap T3, it becomes possible to make the exposed amount D be “0 g”. In other words, there is no exposure of the lubricant to the end portion of the fixing belt 201 in the longitudinal direction. This is because the move of the lubricant from the central region T1 to the end portion region T2 is limited by the gap T3. In addition, this is because the lubricant which has moved from the central region T1 is absorbed in the end portion region T2.

As in the Embodiment 8, in a case in which the amount of the lubricant in the end portion region T2 is close to “0 (g/mm)” (0.03 (g/mm)), compared to the Conventional Example and the Embodiment 7, it is possible for the end portion region T2 to absorb the lubricant which has moved from the central region T1 more, so that the exposed amount D can be reduced. However, compared to the Embodiment 9, the exposure of the lubricant to the end portion of the fixing belt 201 in the longitudinal direction may occur. This is because the gap T3 is narrow so that the move of the lubricant from the central region T1 to the end portion region T2 cannot be limited completely, and in addition, compared to the case in which the amount of the lubricant in the end portion region T2 is “0 (g/mm)”, it is not possible for the end portion region T2 to absorb the lubricant which has moved from the central region T1 more.

As described above, in the applying roller 400 in the present Embodiment, the gap T3 is formed between the central region T1 and the end portion region T2 with respect to the longitudinal direction. These gaps T3 formed between the central region T1 and the end portion regions T2 limit the move of the lubricant so that the lubricant in the central region T1 does not move to the end portion region T2. As a result, even if the fixing belt 201 is rotated over a long time, it becomes possible with the applying roller 233 to suppress that the lubricant goes around from the inner peripheral surface via the edge to the outer peripheral surface of the fixing belt 201 and is adhered thereto.

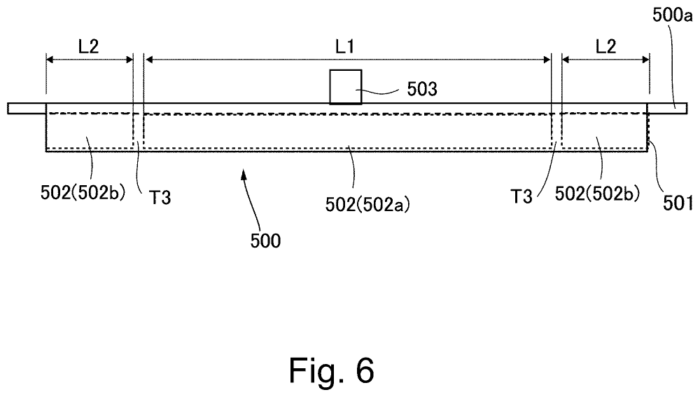

Incidentally, the applying rollers 233 and 400 described above are exemplified by the roll shaped members formed by winding the nonwoven fibers impregnatable with the lubricant around the rotational shaft thereof, however, it is not limited thereto. In FIG. 6, yet another Embodiment of the applying roller is shown. As shown in FIG. 6, in an applying roller 500, a bag shaped portion 501 formed in a bag shape with the nonwoven fibers is adhered to an elongated holding member 500a, and a foamed material 502 (502a and 502b) made of a felt or silicone rubber is disposed in the bag shaped portion 501. The applying roller 500 is non-rotatably supported by the frame of the heating unit 210 (see FIG. 2). In a middle (central) portion of the applying roller 500, a stainless steel thin plate 503 as a pressing portion is provided, and by elastic force of the stainless steel thin plate 503, the applying roller 500 is brought into contact with the inner peripheral surface of the fixing belt 201. At this time, by the foamed material 502 being pressed against the applying roller 500, the lubricant impregnated in the foamed material 502 in advance is applied to the inner peripheral surface of the fixing belt 201.

In the applying roller 500, the foamed material 502 impregnatable with the lubricant includes a first foamed material 502a disposed in a region corresponding to the central region T1 described above in the longitudinal direction and a second foamed material 502b disposed in regions corresponding to the end portion regions T2 adjacent to the end portions of the central region T1, respectively. To the foamed material 502a, the lubricant is supplied from the taking out roller 232 (see FIG. 2). Amounts of the lubricant impregnated in these first foamed material 502a and the second foamed material 502b are the same as the amounts of the lubricant in the central region T1 and the end portion region T2 described above, respectively. In other words, the amounts of the lubricant differ between the first foamed material 502a and the second foamed material 502b.

Incidentally, the first foamed material 502a and the second foamed material 502b may be disposed with the gap T3 described above therebetween as shown in FIG. 6, or may be disposed without the gap T3. However, because the applying roller 500 includes the first foamed material 502a and the second foamed material 502b, compared to the applying rollers 233 and 400 described above, it is easy to provide the gap T3.

Incidentally, in the Embodiments described above, it is configured that the lubricant is supplied to the applying roller 233 (400, 500) by the taking out roller 232, however, it is not limited thereto. The lubricant accommodating member 231 and the taking out roller 232 need not be provided. However, in a case of realizing this, upon impregnating the applying roller 233 (400, 500) with the lubricant through the predetermined way, it is necessary to impregnate the central region T1 with a sufficient amount of the lubricant.

Incidentally, in the Embodiments described above, the case in which the collecting mechanism 220 is provided is described, however, the collecting mechanism 220 need not be provided. This is because, as described above, with the applying roller 233, 400 or 500, it becomes possible to suppress the exposure of the lubricant to the end portion of the fixing belt 201 in the longitudinal direction. However, in a case in which there is the lubricant exposed from the end portion of the fixing belt 201 in the longitudinal direction even upon suppressing the exposure of the lubricant, in order to prevent the lubricant from going around to the outer peripheral surface of the fixing belt 201 and being adhered thereto, it is preferable to provide the collecting mechanism 220.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-176237, filed on Oct. 8, 2024, which is hereby incorporated by reference herein in its entirety.

What is claimed is:

1. A fixing device for fixing a toner image formed on a recording material onto the recording material, the fixing device comprising:
an endless fixing belt;
a stretching roller configured to stretch the fixing belt;
a nip portion forming member provided inside the fixing belt and configured to form a nip portion which fixes the toner image on the recording material;
a pressing rotatable member disposed across the fixing belt opposite to the nip portion forming member and configured to press the fixing belt;
a steering roller configured to move the fixing belt in a widthwise direction crossing a conveyance direction of the recording material; and
a lubricant applying member extended inside the fixing belt and in the widthwise direction, and configured to apply a lubricant to an inner peripheral surface of the fixing belt by contacting the inner peripheral surface,
wherein with respect to the widthwise direction, the lubricant applying member includes a first region, and second regions provided on both ends of the first region and in which an amount of the lubricant contained per unit length is smaller than an amount of the lubricant contained per unit length in the first region, and
wherein in a state in which the fixing belt is deviated in a first direction side most by the steering roller, a belt end portion on a side opposite to the first direction side is positioned in the second region.

2. The fixing device according to claim 1, further comprising
a lubricant accommodating member configured to accommodate the lubricant; and
a lubricant supplying member in contact with the first region of the lubricant applying member and configured to supply the lubricant in the lubricant accommodating member to the first region.

3. The fixing device according to claim 1, wherein a gap is formed in the lubricant applying member between the first region and the second region with respect to the widthwise direction.

4. The fixing device according to claim 1, wherein when the stretching roller is a first roller, a second roller is provided, the second roller stretching the fixing belt with the first roller and being inclinably provided to the first roller to reciprocate the fixing belt in a rotational axis direction of the first roller, and
wherein when a length of the fixing belt in the widthwise direction is defined as Lb (mm), a length of the lubricant applying member in the widthwise direction is defined as Lc (mm), a movement distance of the fixing belt in the widthwise direction which is reciprocated by an inclination of the second roller is defined as L (mm) and a length of the second region in the widthwise direction is defined as L2 (mm), the following relationship is satisfied:
$$1 / 2 ( Lb - Lc ) + L 2 > L .$$

5. The fixing device according to claim 1, wherein the lubricant applying member is drivenly rotatably provided on the fixing belt, and
wherein the lubricant applying member is nonwoven fibers wound around a rotational shaft thereof.

6. The fixing device according to claim 1, wherein the lubricant applying member includes a bag shaped portion formed in a bag shape with nonwoven fibers, a holding member holding the bag shaped portion and a foamed material disposed in the bag shaped portion held by the holding member and impregnatable with the lubricant.

7. The fixing device according to claim 1, further comprising a pressing portion configured to press the lubricant applying member toward the fixing belt.

8. The fixing device according to claim 1, further comprising a removing member in contact with an edge portion of the fixing belt in the widthwise direction and configured to remove the lubricant moved from the inner peripheral surface to an outer peripheral surface of the fixing belt.
